(19) United States
(12) Patent Application Publication
(10) Pub. No.: US 2004/0133888 A1
(43) Pub. Date: Jul. 8, 2004

(54) Wizard-based voice/data telecommunications system installation and configuration tool

(76) Inventors: Delvan Ard, Brighton, CO (US); Elise M. Carr, Westminster, CO (US); Andrew D. Franklin, Boulder, CO (US); Bruce Lieou, Highlands Ranch, CO (US); Karen Cohen Loeb, Englewood, CO (US); John Petruska, Clifton, NJ (US)

Correspondence Address: PATTON BOGGS, 1660 LINCOLN ST, SUITE 2050, DENVER, CO, 80264, US

(21) Appl. No.: 10/211,849

(22) Filed: Aug. 2, 2002

(51) Int. Cl. G06F 9/445; G06F 9/44

(52) U.S. Cl. 717/174; 717/168

(57) ABSTRACT

The installation wizard tool comprises a singular tool that guides the service technician in an ordered manner through the entire installation of an integrated voice-data telecommunications system while also integrating the data obtained from auto-discovery, diagnostics, and customization activities, which tasks are all performed with a single tool, via a common service technician interface. The installation wizard tool is capable of enabling the service technician to complete the installation of an integrated voice-data telecommunications system to the point of functional station-to-station and/or station-to-trunk calling. The service technician only is required to input data that the installation wizard tool cannot discover on its own, or that the service technician desires to change from the default settings. These changes can be implemented without invoking other applications. The installation wizard tool accomplishes this by invoking other applications in a back end mode to render the execution of the tasks transparent to the service technician and managed via the single service technician interface on the installation wizard tool.

### FIELD OF THE INVENTION

This invention relates to the installation, configuration, testing, and administration of telecommunications systems using automated tools to facilitate efficient completion of the service technician's task.

### PROBLEM

It is a problem in the field of telecommunications systems that the installation, configuration, testing, and on-going administration of telecommunications systems are complex tasks that require the use of multiple tools by the service technicians. As a result, these are error-prone processes that are also time-consuming, and therefore costly to the equipment vendor.

Presently, the trend in telecommunications is to install telecommunications systems that provide a converged or integrated voice and data solution to the telecommunications needs of customers. This integrated approach provides a significant improvement over prior integrated voice-data telecommunications systems because the equipment operates as an integrated unit, appearing seamless to the users. The increase in the need to transmit multi-media data and the need to provide concurrent voice services to the customers has created a significant market for telecommunications equipment vendors for voice/data telecommunications systems.

However, the installation, configuration, testing, and on-going administration of these integrated telecommunications systems is presently done in a piece-wise, fragmented manner. The service technician is provided with a number of equipment installation, configuration, testing and administration tools (termed “installation tools” herein), each of which is used for a particular, narrowly defined purpose. Furthermore, many of these installation tools are capable of interfacing only with proprietary components of the telecommunications system and cannot be used for other components of the telecommunications system or to provide data to other installation tools that the service technician uses to install these other components. This represents a significant problem since the trend in telecommunications systems is to provide an open interface that supports the components of many vendors.

Many existing installation tools use wizard technology, which consists of quasi-expert system guided processes, to simplify the execution of some high runner functions, but they fail to guide the service technician through all of the steps required to install the entire integrated voice-data telecommunications system, configure the system to the particular specifications of a particular customer, test the installation as it progresses, and then administer the system once it is functioning. The number of possible data entry screens that are available for use in installing and configuring a modern voice-data telecommunication system can number over 700, with thousands of data entries being required to define the operating parameters of the system, which are necessary to install and configure the system to an operational state.

For example, one of the existing installation tools simplifies only the task of translation table input over a very large number of system administration screens, using a domain expert. This installation tool facilitates the laborious task of providing the data that maps the subscriber identity to a telephone extension number to a particular piece of communications equipment. However, this installation tool fails to provide a complete, compact guide of ordered installation steps using wizard technology that integrates and interrelates information across screens, deduces dial plans, and incorporates data from auto-discovery and diagnostic activities. Thus, the service technician must use other installation tools to perform these functions or must manually execute these tasks, even though the installation tool simplifies the identification of the installed equipment components. Installation tools that use auto-discovery applications to identify the installed equipment components, their present settings, and capabilities require switching among many installation tools to complete the installation and testing of these equipment components and some of these auto-discovery-based installation tools require resetting of the default settings for the installed equipment components. Furthermore, some systems require pre-staging of configuration data, prior to the installation of the equipment. This process leads to a significant number of errors since the physical installation invariably differs from the planned installation, thereby creating additional work for the service technician in having to correct the differences between the planned and actual installation and configuration.

This lack of integration among the various installation tools increases the complexity of the equipment installation for the service technician. Thus, the present installation tools that are used to install the integrated voice-data telecommunications system solve isolated problems at the expense of other functions that need to be performed. There is presently no singular tool that guides the service technician in an ordered manner through the entire installation of an integrated voice-data telecommunications system, while also integrating the data obtained from auto-discovery, diagnostics, and customization activities.

### SOLUTION

The above-described problems are solved and a technical advance achieved by the present wizard-based voice/data telecommunications system installation and configuration tool, termed “installation wizard tool” herein, which comprises a singular tool that guides the service technician in an ordered manner through the entire installation of an integrated voice-data telecommunications system while also integrating the data obtained from auto-discovery, diagnostics, and customization activities, which tasks are all performed with a single tool, via a common service technician interface. There is no outside network connectivity assumed in completing the installation and configuration of the telecommunications system, the work can be substantially completed and validated prior to connection of the telecommunication system to the common carrier network facilities. Furthermore, the installation wizard tool can assign the IP addresses for the servers and the configuration tasks can be performed remotely.

The present installation wizard tool is capable of enabling the service technician to complete the installation of an integrated voice-data telecommunications system to the point of functional station-to-station and/or station-to-trunk calling. The installation wizard tool is a browser-based process that satisfies a number of service technician-friendly attributes: easy to learn, enhances the performance of the service technician, easy to remember, low error rate, easy error recovery, and pleasant to use. The service technician is only required to input data that the installation wizard tool cannot discover on its own, or that the service technician desires to change from the default settings. These changes can be implemented without invoking other applications. The installation wizard tool accomplishes this by invoking other applications in a back end mode to render the execution of the tasks transparent to the service technician and managed via the single service technician interface on the installation wizard tool.

The installation wizard tool functions to guide the service technician through an ordered presentation of the steps that are necessary to install and configure the telecommunication system. The interrelationships among the numerous steps are maintained by the installation wizard tool and the order of presentation is based on the present context of the installation, and the data entries that are required from the service technician. Much of the data is automatically located, excerpted or determined by the installation wizard tool using a number of sources, to thereby minimize the data entry required by the service technician.

The installation wizard tool manages the configuration of servers, including the assignment of IP addresses of the servers, loading of software license and password files, automatic updating of firmware and software, configuration of telephony endpoints and network trunks.

### BRIEF DESCRIPTION OF THE DRAWING

FIG. 1 illustrates in block diagram form the overall architecture of the present installation wizard tool;

FIG. 2 illustrates in flow diagram form the operation of the present installation wizard tool in the installation of an integrated voice-data telecommunications system;

FIG. 3 illustrates in block diagram form a typical application of the present installation wizard tool in the installation of an integrated voice-data telecommunications system; and

FIGS. 4 & 5 illustrate in flow diagram form, the operation of the installation wizard tool in the generation of a view object in response to receipt of a service technician request.

### DETAILED DESCRIPTION

The installation wizard tool comprises a singular tool that guides the service technician in an ordered manner through the entire installation of an integrated voice-data telecommunications system while also integrating the data obtained from auto-discovery, diagnostics, and customization activities, which tasks are all performed with a single tool, via a common service technician interface. The installation wizard tool is capable of enabling the service technician to complete the installation of an integrated voice-data telecommunications system to the point of functional station-to-station and/or station-to-trunk calling. The service technician only is required to input data that the installation wizard tool cannot discover on its own, or that the service technician desires to change from the default settings. These changes can be implemented without invoking other applications. The installation wizard tool accomplishes this by invoking other applications in a back end mode to render the execution of the tasks transparent to the service technician and managed via the single service technician interface on the installation wizard tool.

Installation Wizard Tool Application

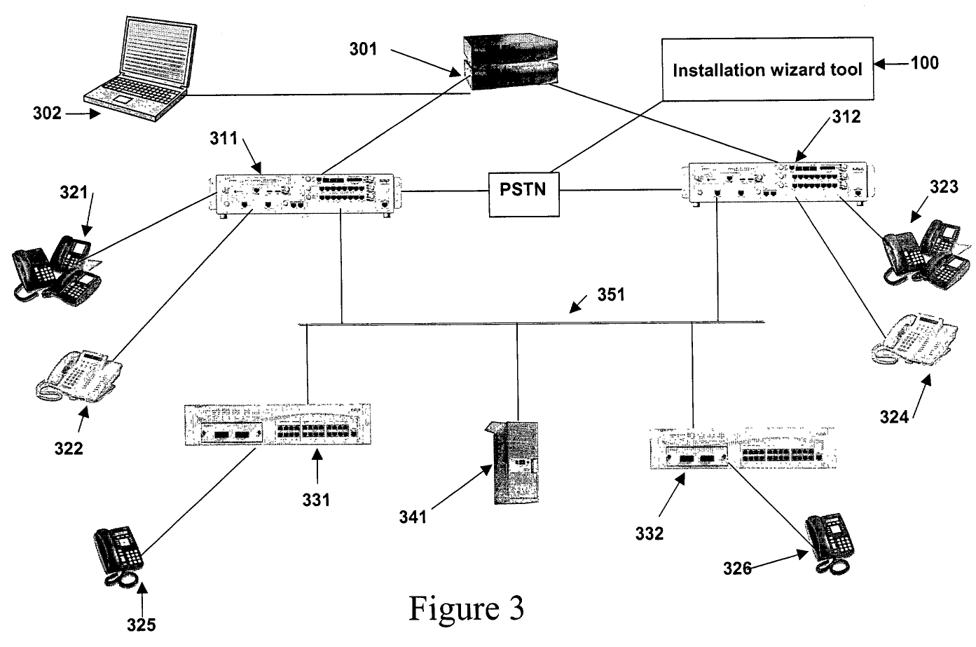

FIG. 3 illustrates in block diagram form a typical application of the present installation wizard tool 100 in the installation of an integrated voice-data telecommunications system. The following description notes the fundamental elements that comprise a modern integrated voice-data telecommunications system and provides an insight into the complexity of the task that is encountered in having to install, configure, test, and administer such a telecommunications system. For simplicity of description, the Web server that supports the installation wizard tool 100 is not shown, the presence of the installation wizard tool 100 is simply illustrated conceptually as accessible via a Local Area Network.

An integrated voice-data telecommunications system is embodied in Avaya's Enterprise Class IP Solutions (ECLIPS) which provide customers with a powerful way to capitalize on the benefits of IP Telephony—lowering operational costs and improving productivity. ECLIPS was designed to IP-enable the DEFINITY® server, install an IP centric solution with a Communications Server, or a combination of both—enabling customers to deploy IP telephony when and where it makes sense for their business. The Avaya MultiVantage™ software—evolved from DEFINITY software—continues the evolution of the Enterprise Class IP Solutions. Avaya provides a modular mix-and-match media server and media gateway architecture driven by Avaya MultiVantage, allowing the customer to experience custom converged networks with massive, distributed scalability and powerful performance.

Components of a Typical Telecommunication System

Enterprise Class IP Solutions (ECLIPS) deliver the scalability, ease of use, reliability and power of the voice network to IP telephony. They provide applications interoperability—which helps to reduce service technician disruption—and centralized support for remote LANs and IP devices, promoting workforce mobility. ECLIPS components are designed to offer standards-based platforms, work in multi-vendor environments and scale to meet changing customer needs. ECLIPS components include:

Avaya MultiVantage™ Software

Avaya MultiVantage, evolved from DEFINITY® software, and delivers powerful Enterprise Class IP Solutions, including intelligent call processing, comprehensive service technician and system management, application integration, and enterprise communications networking. It then goes further, by offering robust new enhancements—a common hardware and software architecture, significant increases in scalability and processor call capacity, and expanded telephony features for remote site survivability. MultiVantage also effectively supports the increasing security demands of today's virtual business environment.

Avaya™ Media Servers

This family of application-enabling processing platforms is based on industry standard operating systems. Avaya Media Servers 301 provide high-performance centralized call processing that may be distributed across a multi-protocol network 341. They are effective in PBX and IP-based systems, giving them the flexibility to support highly diversified and multi-site network architectures.

Avaya™ Media Gateways

These stackable and modular hardware elements 311, 312 deliver application-enabling data, voice, fax and messaging capabilities to your network. They support both bearer and signaling traffic routed between packet-switched and circuit-switched networks.

Avaya™ Communication Devices

Avaya offers a wide choice of flexible, intelligent, easy to use communication devices 321-326 to meet a customer's unique needs, including: analog, digital, and IP telephones to IP screenphones, IP softphones, IP Softphone for Pocket PCs, and softconsoles. These devices are served by either an associated media gateway 311, 312 or a switch 331, 332, as a function of the capabilities of the communication unit.

Audix

Audix 341 is Avaya's voice messaging system that enables a calling party to provide the called party with a voice message in the case where the called party is unavailable to receive the incoming call. A number of message management options are provided to the service technicians to enable the customized management of messaging services for the service technicians.

MultiService Networking Infrastructure

Avaya MultiService Networking Infrastructure (MSNI) products deliver end-to-end quality of service, including the capability to prioritize and control network use by applications and service technician type. MSNI eases concerns about migration by minimizing disruption—building on current functionality, maintaining reliability of existing systems, and providing future investment protection. MSNI supports IP-enabled applications for customer relationship management, voice over IP, unified messaging, distance learning and collaborative video. It also goes a step further to enable applications like process control, services delivery and supply chain management.

These components represent some of the modules that can be combined by a customer in implementing an integrated voice-data telecommunications system. The tasks facing a service technician where they must install the entire integrated voice-data telecommunications system, configure the system to the particular specifications of a customer, test the installation as it progresses, and then administer the system once it is functioning, are complex and represent a major undertaking.

Installation Wizard Tool Architecture

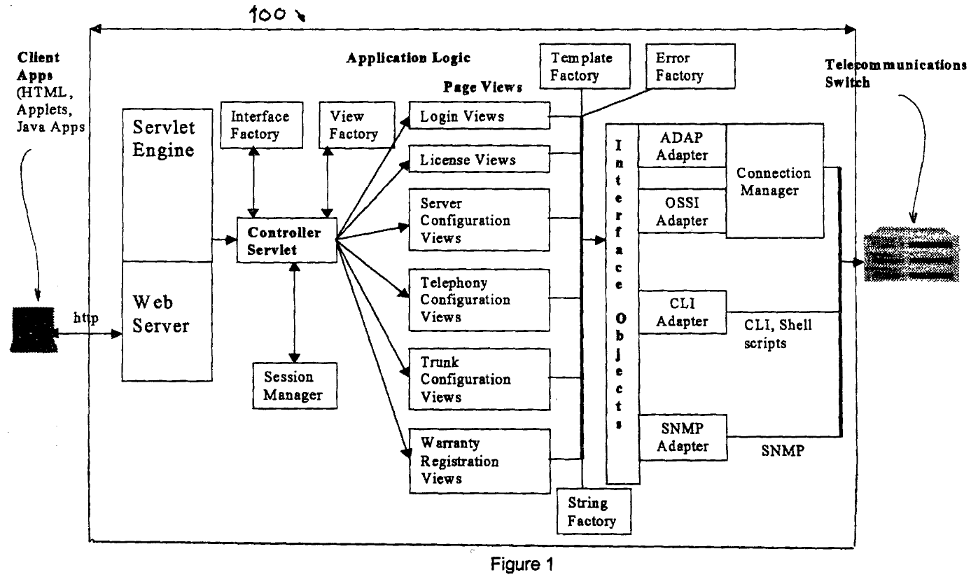

FIG. 1 illustrates in block diagram form the overall architecture of the present installation wizard tool 100 and the following Table 1 provides a brief summary of the functions performed by the elements disclosed in FIG. 1 and the following description provides additional details.

| Element | |
|---|---|
| Name | Element Definition |
| Web Server | Web Server that services HTTP requests. |
| Servlet | Servlet engine that executes HTTP servlet requests. |
| Engine | |
| Controller | The main servlet that initially receives and |
| Servlet | dispatches each installation wizard tool servlet |
| | request. |
| Session | Object that keeps track of persistent session data |
| Manager | and manages the flow between installation wizard |
| | tool pages. |
| Interface | A factory object that the View objects can use to |
| Factory | gain access to objects that interact with the |
| | ECLIPS Server. This factory can be used for local, |
| | library-based objects or to support remote access. |
| View | A factory object that is used to manufacture view |
| Factory | objects as required by the various installation |
| | wizard tool pages. |
| Views | Each View object is responsible for performing |
| | the request associated with the view (with the |
| | help of the Interface Objects), populating the |
| | Velocity context with the objects needed by |
| | the associated Velocity template and returning |
| | the appropriate Velocity template file name. |
| | The Velocity template is used to render the |
| | HTML for the associated web page. |
| Template | A factory object that is capable of manufacturing |
| Factory | Velocity template file names. The equipment |
| | vendor can define various templates to create |
| | a customer or vendor specific template that |
| | defines default values for many of the operating |
| | parameters for the equipment. |
| String | A factory object that is capable of returning |
| Factory | the localized string associated with a given |
| | request parameter. The String Factory loads a |
| | property file that contains all the strings |
| | used to construct all the installation wizard |
| | tool pages for the selected language. |
| Error | A factory object that is capable of returning |
| Factory | the localized string associated with a given |
| | error code. The Error Factory loads a property |
| | file that contains all the error strings used |
| | to construct all the installation wizard tool |
| | pages for the selected language. |
| Interface | Interface objects (Java Interfaces) that |
| Objects | provide the Application Program Interface used |
| | by the Views to perform all installation wizard |
| | tool functions that require an interaction |
| | with the ECLIPS Server. |
| ADAP | Objects that implement the Interface Objects |
| Adapter | that perform AUDIX related features. These |
| | objects actually provide the AUDIX functionality |
| | needed by the Views in order to perform all |
| | installation wizard tool functions. |
| OSSI | Objects that implement the Interface Objects |
| Adapter | that perform MultiVantage Administration related |
| | features. These objects actually provide the |
| | OSSI functionality needed by the Views in order |
| | to perform all installation wizard tool functions. |
| CLI | Objects that implement the Interface Objects |
| Adapter | that perform shell and command line interface |
| | related features. These objects actually provide |
| | the shell and Command Line Interface (CLI) |
| | functionality needed by the Views in order to |
| | perform all installation wizard tool functions. |
| SNMP | Objects that implement the Interface Objects |
| Adapter | that perform Simple Network Management Protocol |
| | (SNMP) related features. These objects actually |
| | provide the SNMP interface to perform |
| | administration and status functionality needed |
| | by the Views in order to perform all |
| | installation wizard tool functions. |
| Connection | The portion of the existing Enterprise Management |
| Manager | Connection Server that provides connectivity to |
| | OSSI. |

Velocity

The Velocity software consists of an open software program that is publicly available and is used to dynamically generate the content of HTML pages.

Controller

The Controller is the sole servlet in the installation wizard tool 100 and is responsible for fielding all HTTP requests. The responsibilities of the Controller include:

1. Asking the Session Manager to determine the current page view.

2. Invoking the View Factory to manufacture the associated Page View object.

3. Invoking the Page View object to process the request, populate the Velocity context and return the appropriate Velocity template.

4. Constructing and returning a Velocity Template object from the Velocity template file name returned by the Page View. The parent context then generates the HTML using the Velocity context and template.

Session Manager

The interaction between a typical Web server and a Web browser is stateless. Therefore, when a client Web browser sends a request to the Web server, the Web server responds with the requested resource and closes the connection. After closing the connection, the Web server does not remember any information about the client Web browser. This inability to remember session information is unacceptable for Web-based installation applications.

The installation wizard tool's Session Manager is therefore responsible to create and maintain information about an installation session and also to coordinate the flow of data used by the installation wizard tool.

When the Web browser connects to the Web server for the first time, the CGI program creates and assigns it a unique identification code, creates and saves that code in a form of a cookie on the client's Web browser and also in a property file on the Web server. This code uniquely identifies that service technician's installation session. When the Session Manager is instantiated, it first determines whether or not this is a new installation. If this is a new installation the Session Manager creates a new Session Property object and loads it with the initial property file that was created by the CGI program that formats the Web pages. This property file contains the session id, service technician login, login type etc. If this is an existing installation, the Session Manager creates a new Session Property object and loads it with the previously saved session. Every page is responsible for saving its data by invoking the setAttribute (String key, String value) method of the Session object followed by a call to Save( ) at the end to write the data in memory to persistent storage. The next time that page is loaded, the page is responsible to restore its previously saved data by calling the getAttribute (String key) of the Session object.

In summary, the Session Manager provides the following capabilities:

1. Create a new session

2. Restore an existing session

3. Store and retrieve attributes of individual page

4. Determine next page

5. Look up current page name

6. Store and retrieve page's status

View Factory

The View Factory is responsible for manufacturing Page View Objects. The Controller supplies a Page View name from which the page View Object is manufactured using dynamic class construction techniques.

View Objects

View Objects are responsible for performing requests that are initiated from the previous Web browser page and preparing response pages. A typical View will:

1. Get request parameters from the HTTP Servlet Request object

2. Perform installation wizard tool requests using Interface Objects

3. Set page status

4. Populate persistent data in the Session Manager

5. Populate the Velocity context

6. Return the Velocity template used to render the HTML response page.

Interface Factory

The Interface Factory is responsible for manufacturing Interface Objects that are used by the Page Views to effect ECLIPS Server configuration. The Page Views supply an interface name from which the Interface Object is manufactured using dynamic class construction techniques.

Thus, the basic architecture of the installation wizard tool 100 is to provide a service technician interface that is Web-centric while providing back end processing of the installation and configuration data, in a manner that is transparent to the service technician. The installation wizard tool 100 makes use of a number of automated processes to obtain the relevant data necessary to configure the telecommunications system and maintains a flexible architecture that accepts vendor customization and supports the implementation of additional components of the telecommunication system. The use of the various modules noted above provides the adaptability required to serve numerous components of the integrated voice-data telecommunication system in an integrated manner.

View Generation Process

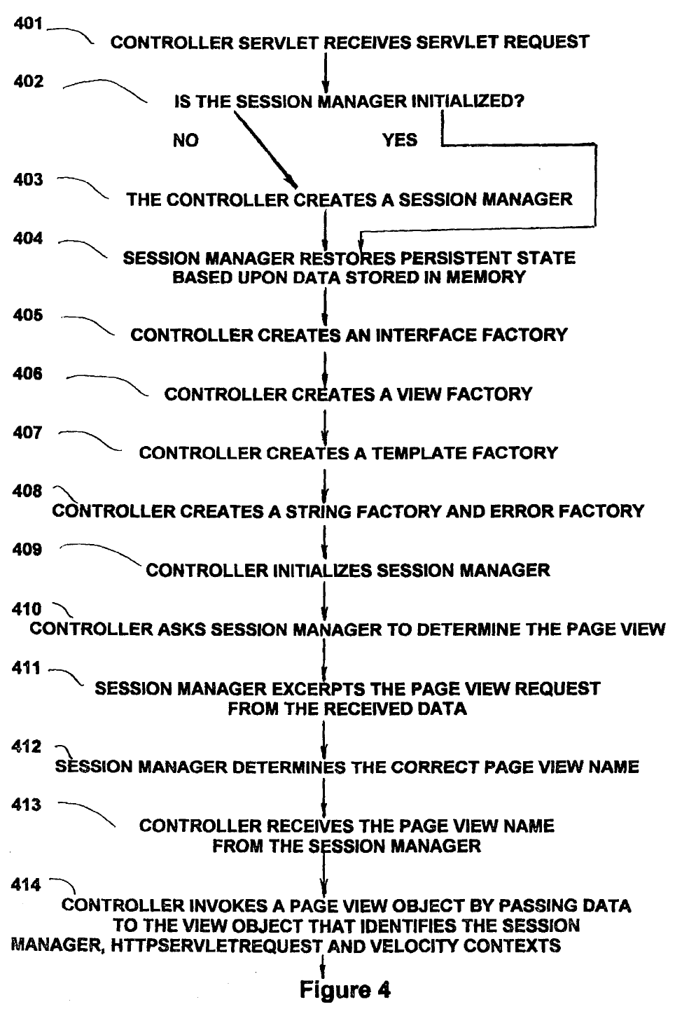

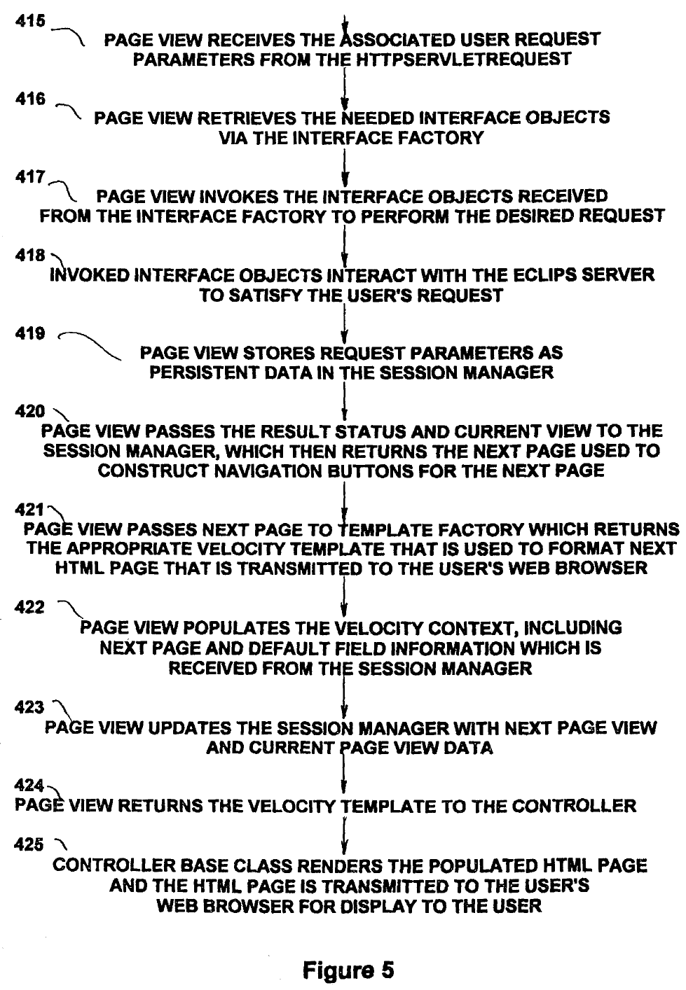

In order to further illustrate the operation of a View, FIGS. 4 & 5 illustrate in flow diagram form the operation of the installation wizard tool to respond to a service technician request and generate a view that is appropriate for the task being executed by the service technician. In this process, the service technician at their Web browser typically activates a displayed option to request the installation wizard tool 100 to provide information to the service technician. The service technician's actions on the Web browser are transmitted in well-known fashion to the Web server, where they are processed.

At step 401, the Controller servlet receives, via the Web server, a servlet request that is typically generated by the service technician's Web browser. Upon receipt of the request, at step 402, if the Session Manager has not been initialized, then at step 403 the Controller creates a Session Manager. If at step 402, the Session Manager had been initialized, step 403 would be bypassed. The Session Manager restores persistent state (if any) at step 404, based upon data stored in memory to retain the relevance of the session with the service technician. At step 405, the Controller creates an Interface Factory, at step 406 the Controller creates a View Factory, at step 407 the Controller creates a Template Factory and at step 408 the Controller creates a String Factory and Error Factory using the selected locale. These objects are used by the Controller to provide the interactions with the service technician via the Web server-Web browser connection.

Once these preliminary activities are executed, the Controller initializes Session Manager using these Interface, View, String, Error and Template Factory objects at step 409. At step 410, the Controller asks Session Manager to determine the page view by passing a HTTP Servlet Request message to the Session Manager, having a query content that identifies the requested data. At step 411, the Session Manager excerpts the page view request from the received HTTP Servlet Request data and at step 412, the Session Manager determines the correct page view name from the persistence data that is stored in memory and associated with this requesting service technician. The Controller at step 413 receives the page view name from the Session Manager and used this received data to retrieve the associated page view from the View Factory. At step 414, the Controller invokes a page view object by passing data to the View object that identifies the Session Manager, HTTP Servlet Request and Velocity contexts so the View object can appropriately populate the view that is provided to the service technician via the Web server-Web browser connection. At step 415, the Page view receives the associated service technician request parameters from the HTTP Servlet Request and at step 416 the Page view retrieves the needed interface objects via the Interface Factory. At step 417, the Page view invokes the interface objects received from the Interface Factory to perform the desired request. These invoked Interface Objects interact with the ECLIPS Server at step 418 to satisfy the service technician's request.

At step 419, the Page view stores request parameters as persistent data in the Session Manager in order to maintain the context of the interactions with the service technician. Then, at step 420, the Page view passes the result status and current view to the Session Manager, which then returns the next page used to construct navigation buttons for the next page. The Page view passes the next page to the Template Factory at step 421, which returns the appropriate Velocity template that is used to format the next HTML page that is transmitted to the service technician's Web browser. At step 422, the Page view populates the Velocity context, including next page and default field information which is received from the Session Manager. At step 423, the Page view updates the Session Manager with next page view and current page view data and at step 424, the Page view returns the Velocity template to the Controller. The Controller base class (Velocity Servlet) renders the populated HTML page using the Velocity context and Velocity template at step 425 and the HTML page is transmitted to the service technician's Web browser for display to the service technician.

This process illustrates the coordinated, yet atomic approach used to manage the presentation of data to the service technician. The use of this architecture enables the installation wizard to be populated with component-specific data, yet to also maintain an all-inclusive, open interface perspective to the installation process.

OSSI Interface Objects

The OSSI Interface Objects define the objects that interface with the Call Processing (such as the MultiVantage call processing software) to execute the Call Processing Administrative related commands. These objects provide the Views the required OSSI functionality to perform Call Processing-related installation wizard tool functions. These OSSI Interface Objects are reusing existing code/capabilities in the Enterprise Management's Connection Server to interface to Call Processing.

The present approach for these Interface Objects is based on OSSI command mapping. This means that there is one OSSI Interface Object for every OSSI command that installation wizard tool uses. Each Interface Object provides the set and get method for every required attribute in addition to the Read, Change and Add methods where appropriate.

Media Gateway Adapter

The Media Gateway Adapter provides an interface for executing Command Line Interface commands that configure the non-Internal Communication Controller elements of a call processing stack. There is an interface for each command implemented. Each command's interface has methods that allow input parameters to be entered. There is also an execute method, that executes the command on the command line interface, with any parameters that have been given the command through its set methods.

Typical Operation of the Installation Wizard Tool

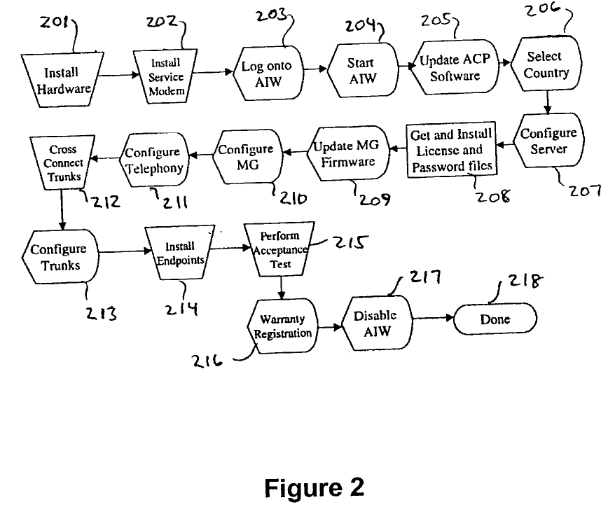

FIG. 2 illustrates in flow diagram form the operation of the present installation wizard tool 100 in the installation of an integrated voice-data telecommunications system. The installation wizard tool 100 guides the service technician through the steps illustrated in FIG. 2 to enable the service technician to complete the installation of an integrated voice-data telecommunications system to the point of functional station-to-station and/or station-to-trunk calling.

The first step in any equipment installation is the physical configuration of the equipment and the mechanical and electrical interconnection of the various components that comprise the telecommunications system. The service technician performs this task at step 201 and, upon completion of the basic system installation, and prior to the connection of the telecommunication equipment to any common carrier network facilities, the service technician installs or activates an interface card at step 202, which is connected to the Ethernet port of the Media Server 301 of the telecommunications system to thereby enable the service technician to obtain access to the Internet via the server. The installation wizard tool 100 resides and executes on an Internet-based Web server, which is accessed by the service technician obtaining dial access to the Web site by inputting the URL of this Web site. Alternatively, the installation wizard tool can reside on the service technician's laptop 302 and execute thereon to provide the services noted below.

For simplicity of description, the Internet Web site approach is described herein. In this environment, the service technician must log in to the installation wizard tool Web site by providing the proper service technician identification and service technician authentication data at step 203.

Login View

The login view, as shown in FIG. 1, is responsible for authenticating that a valid login and password were entered. Additionally, upon valid login, the Login view shall enable the execution of the installation wizard tool 100, create a session file and redirect the service technician's Web browser to the first page of the installation wizard tool application. Upon login, the preferred locale is garnered from the initial HTTP request. This locale setting is used to create the String Factory and Error Factory objects that are used to present all Web browser text in the preferred language. The Welcome view is a component of the login process and presents welcome and overview information to the installation wizard tool service technician. The service technician then activates the installation wizard tool 100 at step 204, which automatically determines the present version of the software and firmware that is installed on the telecommunications system server 301.

Update Call Processing Software

At step 205, the installation wizard tool 100 updates the call processing and control software and firmware that resides in the telecommunications system. This software and firmware includes the telecommunications system call processing component, such as the MultiVantage software, as well as any other components that may reside on the telecommunications system. The installation wizard tool 100 automatically updates any of these components with the latest version of the software and/or firmware that is available.

Collect Country And Language Selections

At step 206, the service technician is prompted to provide some basic data that includes the country in which the telecommunications system is being installed and the language selected by the service technician for use in the service technician interface. The installation wizard tool 100 uses this data to automatically set a number of settings for the telecommunications system that are country-dependent as well as language-dependent, such as the displays on the telephone station sets. The installation wizard tool 100 then configures the servers with the basic personality with respect to DHCP, TFTP, DNS, and the like.

Configure Server

The configure server view at step 207 uses a server configure program to actually configure the media server 301 and assign the IP address(es) to the media server 301. The installation wizard tool 100 collects the service technician inputs, verifies them as it goes from page to page, saves the data in the queue files, and finally runs a server configuration process to implement the configuration. In this way, the ancillary tasks of the configure server process, which are not tied to any configure page, are also done and the service technician is guided through only the steps that require the attention of the service technician. In this manner, many intermediate steps can be executed automatically by the installation wizard tool 100 as a background process thereby simplifying this configuration step and minimizing the possibility of errors.

The present server configuration data is initially gathered by Configure Interface object (when the init method is called). These data are written to different files in the form of property files in a designated configuration file directory. When the service technician goes through the server configuration pages, the corresponding interface object merely retrieves the current setting from the related queue file and displays them to the service technician. For example, when the service technician comes to configure DNS page, the DNS Interface object brings all the DNS information from a configure DNS queue file and presents this data to the service technician. After the service technician changes any setting, the information is written back to the related configuration file by the interface object. For example, if the service technician changes the DNS setting, the DNS Interface object writes the updated information back to the configure DNS queue file.

At the end of the server configuration, the Configure Interface object's commit method is called to apply the service technician entered configuration data. The commit method in turn invokes the configure program to evaluate the completeness and accuracy of the service technician provided data and then proceeds to do the entire configuration on the actual hardware and software.

Once the basic interface specifications are resolved, the installation wizard tool 100 must install the software licenses and password files at step 208 to enable activation of the telecommunications system. The MultiVantage software is protected by software license and password files, and other components of the telecommunications system may optionally also be similarly protected. The installation wizard tool 100 automatically loads and installs the associated software license and password files on the primary server of the telecommunications system.

The installation wizard tool 100 then checks the version of the software that is presently installed on the Media Gateway 311, 312 and updates this software as necessary at step 209. At this juncture, the servers 301, 311, 312 are active, having been updated with the latest software and being configured at step 210 as necessary to enable the telecommunications function to be installed to run on this backbone. The installation wizard tool 100 imports data from available sources, such as customer/service technician provided translation files that define the equipment to service technician to telephone number translations. In addition, default settings for components are detected and imported into the call processing and system configuration files to enable the installation wizard tool 100 to populate the telephony parameters necessary for the basic installation of the telecommunications system at step 211. In addition, the installation wizard tool 100 manages auto-detect modules of the MultiVantage system to identify the physical equipment that is used to implement the telecommunications system as well as the settings presently used for these modules.

The process of configuring the various components that comprise the telecommunications system is noted in part below to provide an indication of the nature and complexity of this process. These processes are part of the Telephony Configuration Views that is shown in FIG. 1. The various views that are presented to the service technician include data entry fields that enable the inputting of the necessary telecommunications system operating data, such as line numbers, trunk settings, and the like. The installation wizard tool 100 can automatically import data from various sources, as is noted in a number of examples below, to thereby automatically populate many of the data entry fields with the operating data. The data entry fields can be presented to the service technician in the form of electronic forms or work sheets that present the context for the data entry.

Collect the Number of Extension Range Set

The Extension Range View accepts the number of the extension range sets from the service technician. This parameter is used to determine how many text fields should be displayed when asking the service technician to enter extension range sets.

Collect Route Pattern Parameters

The Route Pattern View configures the route patterns after accepting route pattern parameters from the service technician. The Route Pattern View sends changing ARS analysis requests to the ARS Analysis Administration. After that the Route Pattern View sends adding trunk group request to Trunk Group Administration. Finally, the Route Pattern View sends route pattern configuration requests to the Route Pattern Admin to set the pattern number 1 to be the local calls and 2 to be the long distance calls. The Route Pattern View calls the Default Configuration Manager to complete the rest of the telephony configuration.

The Initial Extension Range View process asks the service technician to enter the number of the extension range sets and validates the following things:

The number of extension range sets is not zero.

The number of extension range sets is integer.

Configure Dial Plan

The Dial Plan View checks if the service technician did not enter over-wrapped extension ranges. If the service technician inputs are valid, then the Dial Plan View sends dial plan requests for the feature access codes, endpoint extensions, and an Audix extension to the Dial Plan Analysis Administration.

The Initial Dial Plan View process accepts extension range sets from the service technician and validates the following things:

An extension consists of only integers.

The length of an extension is more than equal to 4 and is less than equal to 7.

The service technician fills out all text fields.

Collect an Audix Extension

The Audix Extension View accepts an Audix extension from the service technician and configures the extension.

Import Name and Number List View

The Import List View accepts a name and number list from the service technician and parses the file contents. While parsing the file, The Import List View checks the following things:

1. An endpoint service technician's name, a desired endpoint extension, and an endpoint set type are specified.

2. An extension matches to the dial plan.

3. An endpoint set type is one of the types the installation wizard tool supports.

The Import List View can receive data from a customer-provided file wherein a customer having an existing dial plan can simply use this data to populate the new telecommunications system. Thus, the service technician can import a data file that comprises the subscriber name and extension number list from the customer's published telephone directory information. This data is used by the installation wizard tool 100 to populate the data fields of the dial plan screens without the need for service technician intervention or manual data entry, which is both time consuming and error prone.

Default Configuration

The Default Configuration Manager calls classes which configure the rest of telephony. The responsibilities of the Default Configuration Manager includes:

Getting the country selection from the Session Manager.

Invoking a class which implements the following interfaces by passing an interface objects as a parameter. A class implementing the following interface is determined by the country view selection. In addition, the typical classes include, but are not limited to: class of service, class of restriction, coverage path, feature access codes and station configurations.

The service technician then temporarily logs off the Web site at step 212 and returns to the next step of the physical installation of the telecommunications system which comprises the cross connection of the trunks and the testing and diagnosis of the trunk installation. Once the cross-connection process is completed, and network connectivity is obtained, the service technician returns to the installation wizard tool 100. The installation wizard tool 100 manages auto-detect modules of the MultiVantage software and other such capabilities in the various components of the telecommunications system to identify the type of trunk, country settings for signaling, parameter settings, and status of trunk installation at step 213. In addition, vendor specific templates can be accessed to customize the default settings for this installation. Trunk diagnostics can also be launched from the installation wizard tool 100 to provide the service technician with key information for trouble-shooting, if there is any problem encountered in trunk installation. The service technician also adjusts the trunk parameters to maximize voice quality of the communication links to the PSTN. This trunk configuration process includes the following steps used to implement the physical connection of the telecommunications system to the PSTN and other communication media.

List Trunks View

The List Trunks view is responsible for displaying all trunk media modules that are present. Additionally, the service technician shall be able to select one of the displayed trunk modules. Once selected, the following buttons are enabled for the trunk module:

Autosense

Configure

Once a trunk has been auto sensed or configured, the configured Field is set and a Status button is enabled.

Auto-Sense Trunk View

The Auto-Sense Trunk view is responsible for conducting a series of tests to determine what framing and signaling is being used on the other end of the trunk. The resulting settings are displayed to the service technician, who has the opportunity to accept or customize them. This function requires connection to the PSTN to implement this step.

Configure Trunk View

The Configure Trunk view is responsible for allowing the installation wizard tool service technician to enter trunk information needed to fully administer the trunk.

Trunk Status View

The Trunk Status view is responsible for displaying the trunk status, which may include signaling group and trunk group status.

Trunk Diagnostic View

The Trunk Diagnostic view is responsible for conducting a series of tests and displaying the results in a readable form. The diagnostics can be resident in a number of locations and typically are found in the telecommunications system, where they are used for ongoing maintenance of the equipment. This function requires connection to the PSTN to implement this step.

These above-noted processes are included in the step of acceptance testing, step 215, shown in FIG. 2 and result in the operational telecommunications system being in a state that it can be registered with the registration database resident in the Web server as an operational telecommunications system, subject to the warranty terms and conditions.

Warranty View

Therefore, at step 216, the installation wizard tool 100 automatically registers the warranty information by gathering customer data and transmitting this data to the Customer Care Center for use when future maintenance is required.

Get Warranty Registration Information

Collect Serial Numbers

Format Warranty Registration E-mail

Send Warranty Registration E-mail

The installation wizard tool 100 has a sub activity called “Warranty Registration” whose purpose is to collect and send the information necessary to activate the warranty service period to the appropriate Customer Care Center. The Warranty Registration information is provided by the technician who installed the system and by automatically gathering serial numbers from the ECLIPS Solution. The collected information is then formatted to a message and stored on the installer's laptop 302. This message file could be sent to the appropriate Customer Care Center at a later time.

Created by the View Factory, the Warranty Registration View is responsible for collecting the information necessary to activate the warranty service period to the appropriate Customer Care Center. To collect the Warranty Registration information, it also has the following responsibilities:

1. Getting request parameters from HTTP Servlet Request.

2. Storing request parameters as persistent data in the Session Manager. (Customer data)

3. Requesting the SAP order number from the Session Manager.

4. Requesting the customer profile information collected during the License process from the Session Manager.

5. Creating Registration Information Profile objects for collecting Warranty Registration information.

6. Storing the requested customer profile information in the Registration Information object.

7. Requesting the Media Gateway information collected during the Server Configuration process from the Session Manager.

8. Creating the Serial Number Collector object and passing the requested Media Gateway information to it.

9. Creating Email Manager.

10. Updating the Session Manager with current warranty registration information and status.

Registration Information

The Registration Information includes business partner, end customer, service technician, billing information, serial numbers of all the Media Gateways and Media Modules.

Installation Log File

The Installation Log File contains a complete record of all actions taken by the wizard, all settings set stored on the servers, remotely accessible for remote diagnostic purposes and downloadable as a file to tech laptop.

At this juncture, the installation and configuration of the telecommunications system is complete and at step 217 the service technician exits the installation wizard tool and completes the process at step 218.

### SUMMARY

The installation wizard tool comprises a singular tool that guides the service technician in an ordered manner through the entire installation of an integrated voice-data telecommunications system while also integrating the data obtained from auto-discovery, diagnostics, and customization activities, which tasks are all performed with a single tool, via a common service technician interface.

What is claimed:

1. An installation tool for the installation and configuration of communication equipment, comprising:
service technician interface means for providing a service technician with access to said installation tool via a computer;
view generation means for presenting said service technician with information screens for display on said computer to enable said service technician to manage said installation and configuration via data collection fields displayed in said information screens;
data collection means for automatically collecting data that defines said communication equipment and its settings;
data management means for integrating data obtained from said service technician and said data collection means to substantially configure said communication equipment absent the use of additional tools.

2. The installation tool of claim 1 wherein said data collection means comprises:
auto-discovery means for automatically determining information about components of said communication equipment, including protocols used thereon.

3. The installation tool of claim 2 wherein said data management means comprises:
means for applying said automatically determining information to operating data fields of the communication equipment.

4. The installation tool of claim 3 wherein said data management means further comprises:
customization means, responsive to data received from a service technician, for modifying contents of said operating data fields, including those populated by said auto-discovery means.

5. The installation tool of claim 4 wherein said view generation means comprises:
a service technician interface, common to said auto-discovery means and said customization means, for communicating among these means and said service technician.

6. The installation tool of claim 1 further comprising:
diagnostic means for automatically performing diagnostics on said communication equipment and providing guidance to said service technician based upon results obtained from said diagnostics.

7. The installation tool of claim 6 wherein said data management means comprises:
means for applying data input by a one of said service technician and said diagnostic means into presently manipulated operating data fields.
